(19) United States
(12) Patent Application Publication
(10) Pub. No.: US 2002/0097189 A1
(43) Pub. Date: Jul. 25, 2002

(54) Method and system for shielding the human head from electromagnetic radiation from handheld radio communications devices

(76) Inventor: Scott Coloney, Tompkins Cove, NY (US)

Correspondence Address: Carter, Ledyard & Milburn, Suite 300, 1401 Eye Street, Washington, DC, 20005, US

(21) Appl. No.: 09/794,020

(22) Filed: Feb. 28, 2001

Related U.S. Application Data
(63) Continuation-in-part of application No. 09/765,273, filed on Jan. 22, 2001.

(51) Int. Cl. H01Q 1/52; H01Q 1/24

(52) U.S. Cl. 343/841; 343/702

(57) ABSTRACT

A method and system for reducing the exposure of the human head from the electromagnetic radiation emanating from a hand held radio communications device. The system optionally includes in combination the covering of the speaker and the headset leads with a radiation absorbing material, the shielding of the antenna, an embedded directional antenna, a face plate for the ear facing side of the device molded from a radiation absorbing material or having such material embedded therein, the use of a radiation adsorbing paint for the device, a hat or cap of radiation adsorbing material to be worn while using the device, and a radiation adsorbing frame for eyeglasses to be worn while using the device.

### RELATED APPLICATIONS

This application is a continuation-in-part of application Ser. No. 09/765,273 filed Jan. 22, 2001 for Electromagnetic Radiation Shielded Headset and Method.

### BACKGROUND OF THE INVENTION

The present application relates to a method and system for reducing the exposure of the human head to electromagnetic radiation resulting from the use of a hands-free cellular phone or other radio communications device.

Health risks incurred by exposing the human brain to electromagnetic (EM) radiation are well known. An antenna of a cellular phone is a known EM radiation emitter, and various systems exist to protect users from exposure to EM radiation emitted from the antennae of cellular phones.

One known method for reducing the exposure of users of cellular phones to EM radiation is the use of an EM shield around the antenna. For example, the Luxon et al. U.S. Pat. No. 6,095,820 dated Aug. 1, 2000, the Bickert U.S. Pat. No. 5,907,307 dated May 25, 1999, and the Schwanke U.S. Pat. No. 5,657,386 dated Aug. 12, 1997 all disclose EM shielding devices for the antenna of a cellular phone.

A second known method for reducing the exposure of users of cellular phones is to distance the antenna of the phone from the user's head when the phone is in use. For example, the Crowley et al. U.S. Pat. No. 6,112,106 dated Aug. 29, 2000 encloses the phone with its antenna in a docking compartment remote from the user and additionally provides an EM shield for the docking compartment. Distancing the telephone from the user requires either a speaker phone or a headset. Since the use of speaker phones destroys the privacy of the conversation and may annoy others in the vicinity, a headset is often preferred.

A headset, i.e., a device which includes a speaker designed to be worn in the ear cavity of or adjacent to the ear while the phone is in use, allows the user to carry the phone and associated antenna some distance away from the head, e.g., on a belt, and reduces the intensity of the EM radiation reaching the ear from the antenna. However, it does not eliminate the exposure of the user to the EM radiation emanating from the headset speaker and/or the electrically conducting wire connecting the speaker to the cellular phone. Moreover, locating the speaker of the headset in or immediately adjacent to the ear cavity places a source of the EM radiation in the place that allows maximum EM radiation exposure to the brain.

It is accordingly an object of the present invention to provide a novel method and system for reducing the potential injury from EM radiation to the user of a radio communications device.

Another object of the present invention is provide novel EM shielded components for a radio communications device which may be used individually or in combination to decrease the risk of injury from electromagnetic radiation.

A further object of the present invention to provide a novel method and apparatus for reducing the potential injury from EM radiation to the user of a radio communications device by reducing the exposure of the user from the EM radiation emitted from the device's antenna, the device itself, and the device's remote speaker.

Yet another object of the present application is to provide a method of minimizing a cellular phone user's exposure to EM radiation emitted from a hands-free cellular phone and its associated speaker.

Still yet another object of the present invention to provide a novel method and apparatus for reducing the potential injury from EM radiation to the user of a radio communications device by placing an EM radiation shield in the ear of a user of a radio frequency communications device, thereby shielding the user from the EM radiation emitted from the device's antenna, the device itself, and the device's remote speaker.

Still yet a further object of the present invention to provide a novel method and apparatus for reducing the potential injury from EM radiation to the user of a radio communications device by placing an EM radiation shield on the cord and on the remote headset, thereby additionally shielding the user from the EM radiation emitted from the device's antenna, the device itself, and the device's remote speaker.

Yet another object of the present invention is provide a novel EM shielded speaker for a radio communications device.

A further object of the present application is to provide a method of minimizing a cellular phone user's exposure to EM radiation emitted from a hands-free cellular phone speaker.

In one aspect, an EM radiation shield may be placed in the ear of a user of a radio frequency communications device, thereby shielding the user from the EM radiation emitted from the device's antenna, the device itself, and the device's remote speaker.

In another aspect, protection may be provided by the covering of the headset leads with a radiation adsorbing material.

In still another aspect, protection may be provided by the shielding of the external antenna of the device, or by providing a shield within the cover for the device for an embedded or internal antenna.

In yet another aspect, protection may be provided by the use of a device housing molded or otherwise formed from a radiation adsorbing material, or the use of a radiation adsorbing paint or covering for the device.

In yet still another aspect, protection may be provided by a head covering made from a radiation adsorbing material which can be worn during periods of use of the device.

In a further aspect, protection may be provided by the use of eye glasses in which the frames are constructed from radiation adsorbing material and the lens mirrored.

These and many other objects and advantages will be apparent to one of skill in this art upon consideration of the detailed description and the appended drawing.

### BRIEF DESCRIPTION OF THE DRAWINGS

FIG. 1 shows one embodiment of an EM shielded, ear cavity headset connected to a radio-frequency communications device.

FIG. 2 shows one embodiment of an EM shielded speaker held adjacent to an ear by a conventional ear hook.

FIG. 3 shows one embodiment of a speaker molded with an EM shielding composite.

FIG. 4 is a section taken through lines 4-4 of the speaker of FIG. 3

FIG. 5 is a pictorial view showing one embodiment of the speaker cable.

FIG. 6 is a pictorial view of one embodiment of a shielding adaptor which may be used with an antenna, internally or externally of the device.

FIG. 7 is a section taken through lines 7-7 of the adaptor or FIG. 6.

FIG. 8 is a pictorial view of one embodiment of a baseball cap having a radiation adsorbing lining

FIG. 9 is a pictorial view of one embodiment of eyeglasses with radiation adsorbing frames and mirrored lenses.

FIG. 10 is a pictorial view of one embodiment of a handheld communication device with an internal antenna and a radiation adsorbing face plate.

FIG. 11 is a pictorial view of a second embodiment of a handheld communication device with an embedded antenna and antenna shield.

FIG. 12 is a section taken through lines 12-12 of FIG. 11.

### DESCRIPTION OF THE PREFERRED EMBODIMENTS

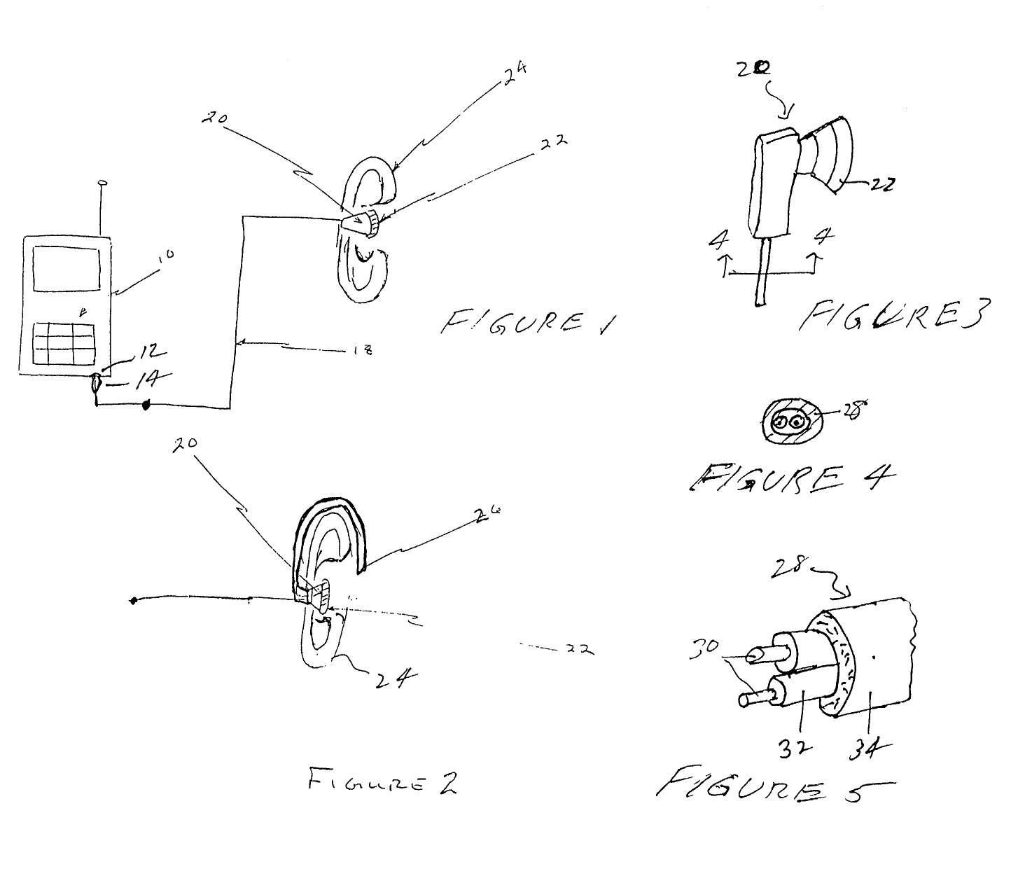

With reference to FIG. 1, a conventional hand held radio communications device 10 such as a cellular telephone is typically provided with an outlet receptacle 12 adapted to receive the jack 14 of a headset which comprises an elongated electrical cable 18 and a speaker 20. The speaker 20 may be of any suitable conventional configuration adapted to be placed into the ear cavity or held adjacent the ear by any suitable conventional means in contact with the head and/or ear of the user of the device. As illustrated in FIG. 1, the speaker is designed to be inserted directly into the ear cavity.

The speaker 20 is covered by any suitable conventional EM radiation shielding material such as a metallic fabric or screen 22. The fabric is desirably flexible and soft to the touch so as not to irritate the ear, and may comprise a woven or pressed fabric or mesh made from one or a combination of electrically conducting fibers such as carbon, lead, potassium, steel, or copper. The shield may be attached to the speaker in any suitable conventional way, e.g., permanently adhered by gluing or removably attached to the speaker by a peripheral elastic band or the like to facilitate removal for cleaning.

Because of its position immediately adjacent the ear, the material provides a shield for the ear of the user from the EM radiation from the antenna, the electrical circuits within the body of the communications device, the electrical connector, and the speaker itself.

In the embodiment of the invention shown in FIG. 2, the speaker 20 is supported adjacent to the user's ear by a conventional holder 26, such as the illustrated ear hook. Other embodiments may be used, e.g., an over-the-head retainer with or without a microphone. As in the previous embodiments, it is desirable that the communications device 10 is retained in a position away from the user's ear while the device is in use. The shield 22 attached to the speaker shields the ear cavity, and thus the brain, from the radiation emitted from the device 10, the electrical cable 18, and the speaker 20.

As shown in FIG. 4, the speaker body may be molded of a suitable plastic material in which shielding powder or fibers have been molded to form a composite material. The composite material may include a woven fabric. The presence of this material (e.g., material such as carbon, lead, potassium, steel or copper) in a matrix of thermoplastics such as polypropylene, thermoset polymers such as polyamide, reaction molded plastics such as polyurethane, and elastomers such as silicones reduces the amount of EM emanating from the speaker body. Alternative matrix materials include ceramics such as silicon carbide and alumina. In addition to conductive material, ferrite or other hysteresis affecting material may be included, either as a powder or as a coating for fibers or a fabric. This shielding material may also be molded into the covering 28 for the headset cable as shown in FIG. 4 over the entire length thereof.

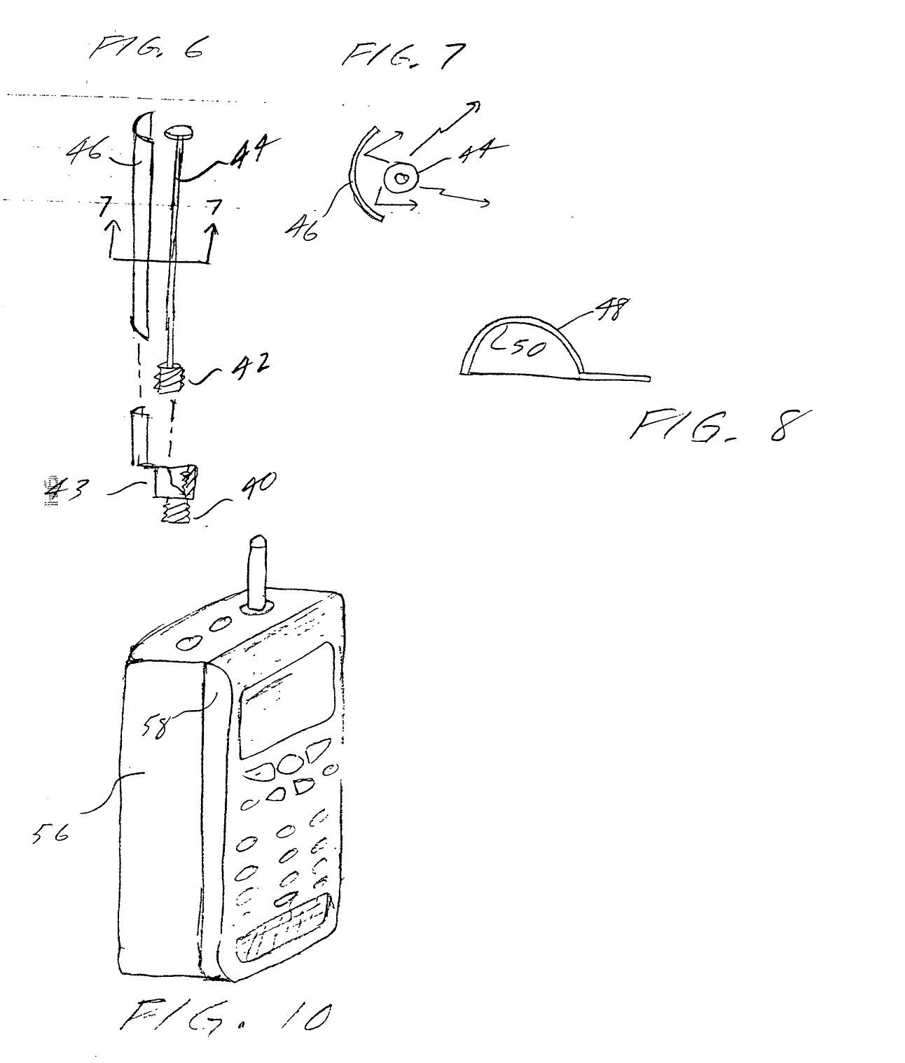

The construction of one embodiment of the speaker cable is illustrated in greater detail in FIG. 5. As shown in FIG. 5, the cable may comprise two wires 30 insulated with a suitable conventional material 32 over which a further sheath of electromagnetic radiation shielding material of the type described herein may be placed over the length of the speaker cable, or the speaker end thereof.

It is desirable to shield the side of the antenna disposed toward the user of the device. As shown in FIGS. 6 and 7, this shielding may be accomplished by an adaptor which includes a threaded portion 40 adapted to mate with the threaded receptacle (not shown) of the device normally receiving the threaded portion 42 of the antenna 44. The threaded portion 42 of the antenna may be received in the internally threaded base 43 of the adaptor. The adaptor desirably includes an arcuate shield 46 which extends the height of the antenna 44 to provide shielding of the antenna on the side thereof nearest to the head of the user, without interfering with the reception of the antenna from other directions. This type of shield may be recessed in the device and pulled therefrom simultaneously with a telescoping antenna. Where the antenna is embedded or encased within the device as shown in FIG. 11, the shielding may also be embedded and oriented such that the shielded area is the area in front of the speaker 60 for the device.

Additional protection may be provided by a head cover such as the baseball cap illustrated in FIG. 8. As shown in FIG. 8, the cap 48 may be provided with a conventional radiation adsorbing material 50, preferably a soft fabric containing conductive wires which may be ferrite coated. Such shielding will reduce the exposure of the user of the communication device from the device as well as from radiation from other sources such as microwave ovens, cellphones, etc.

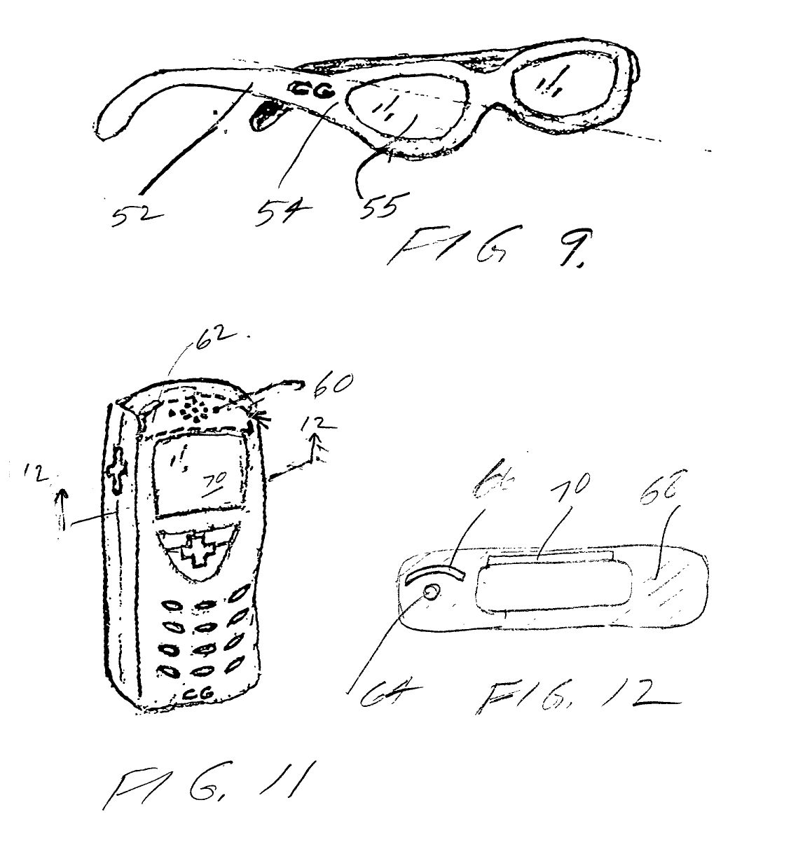

The exposure of the user of the hand held communication device from radiation from the device and other sources may be further reduced by the wearing of eyeglasses such as illustrated in FIG. 9. As shown in FIG. 9, the frames 52 of the glasses are desirably made from a material having EM shielding properties, preferably a composite plastic and EM shielding materials as described above. An alternative is a coating of radiation adsorbing material as heretofore described. It is preferable to expand the area of protection by the use of wide areas 54, and the lens 55 themselves, whether sunglasses or otherwise, may be mirrored to additionally reflect EM and protect the eyes and brain of the wearer.

As illustrated in FIG. 10, the housing 56 for a device having an internal antenna may be provided with a face plate 58 of radiation adsorbing material as described supra. In this way, the user of the device may be protected without interfering with the functioning of the antenna in directions other than the head of the user. In addition, or in lieu thereof, the face plate may be covered with a layer of plastic or other suitable latex or oil based paint into which the particles or fibers discussed above have been mixed. Painting of this type may be desirable to protect sensitive equipment as well as people from radiation.

In a preferred embodiment such as illustrated in FIG. 11, the area 62 of the housing surrounding the speaker 60 desirably includes a conductive fabric as described above, with the remainder of the housing having radiation adsorption materials embedded therein. As shown in the cross-section of FIG. 12, the antenna 64 may be embedded in the housing 68 and partially shielded by a arcuate shield 66 orientated to protect the user of the device.

While preferred embodiments of the present invention have been described, the embodiments described are illustrative only. The protection system of the present invention may include various combinations, e.g., the head covering and eyeglasses of the present invention may be worn with a hand held device or with a remote device with shielded leads and a shielded speaker. However, the scope of the invention is to be defined solely by the appended claims when accorded a full range of equivalents, many variations and modifications naturally occurring to those of skill in the art from a perusal hereof.

What is claimed is:

1. In a hand held radio communications device having an antenna, the improvement including shielding for the antenna only on the side of the device facing the user.

2. The device of claim 1 wherein said shielding is an arcuate EM radiation conducting material extending over an arc of approximately sixty degrees.

3. The device of claim 1 wherein both said antenna and shielding telescopes within the housing of the device.

4. In a hand held radio communications device having an antenna internal of a housing having a face plate which contains dialing push buttons, the improvement wherein the composition of the face plate includes radiation adsorbing material to thereby provide shielding for the antenna on the side of the device facing the user thereof.

5. In a hand held radio communications device having an antenna, the improvement wherein said housing is covered by a layer of radiation adsorbing material to thereby provide shielding for the user on at least the side of the device facing the user when in normal use.

6. A head covering for the user of a hand held radiation device, said head covering including radiation absorbing material to thereby protect the user of a hand held communications device from electromagnetic radiation emanating form the device and its associated equipment.

7. The head covering of claim 6 wherein said head covering is a baseball cap and wherein said radiation absorbing material is a liner comprising a woven fabric with electrically conductive components woven therein.

8. Eye glasses for the user of a hand held radiation device, the frames of said eye glasses including radiation absorbing material to thereby reduce the exposure of the user of a hand held communications device from electromagnetic radiation emanating from the device and its associated equipment.

9. In a hand held communication device, the improvement wherein the antenna is embedded within the device housing and shielded on the side of the device facing the user thereof when the device is in use.
